(19) United States
(12) Patent Application Publication
(10) Pub. No.: US 2011/0145050 A1
(43) Pub. Date: Jun. 16, 2011

(54) Activity-Based Compatibility Testing For Preliminarily Matched Users Via Interactive Social Media

(76) Inventors: Patricia Jane Gross, New York, NY (US); Ian Hughes, Southampton (GB)

(21) Appl. No.: 12/638,677

(22) Filed: Dec. 15, 2009

(51) Int. Cl. G06F 15/16; G06F 3/048; G06Q 30/00; G06Q 50/00

(52) U.S. Cl. 705/14.25; 715/757

(57) ABSTRACT

Matchmaking between a plurality of users is facilitated. This may include providing a virtual space to the users that enables the user to interact in an immersive manner. Matches may be proposed between users, and then activities to be attempted by the matched users may be provided. The activities may be conducted via interactive, electronic social media. The interactive, electronic social media may include the virtual space and/or electronic social media hosted or provided by one or more third-parties. Based on the performance of matched users during an activity, user information may be released to the matched users. As such, before a user is provided with some information related to another user, the user must first participate in an interactive activity with the other user. This may facilitate deeper interactions between matched users.

### FIELD OF THE INVENTION

The invention relates to the activity-based compatibility testing between users that have been matched via preliminary matching criteria. Activities that test compatibility between preliminarily matched users are conducted via interactive, electronic social media.

### BACKGROUND OF THE INVENTION

Services that implement electronic communication media to facilitate romantic matchmaking are known. Generally such services, commonly referred to as “online dating services” enable members to create user profiles that describe themselves and provide, for example, pictures showing their appearance. Members are then able to peruse the user profiles of other users, and to communicate anonymously with each other via a messaging system that is integrated into the service to make introductions and arrange dates in the real world.

Some conventional online dating services leverage matching algorithms that propose matches to users based on user descriptions and/or preferences. These matches may be implemented to facilitate users finding others with whom they may be compatible. Typically, these systems do not rate compatibility of potential matches based on actual interactive activities between the potential matches.

### SUMMARY

One aspect of the invention relates to facilitating matchmaking between a plurality of users. Matches may be proposed between users, and then activities to be attempted by the matched users may be provided. The activities may be conducted via interactive, electronic social media. Based on the performance of matched users during an activity, user compatibility may be evaluated, and user information may be released to the matched users based on this evaluation. As such, before a user is provided with some information related to another user, the user must first participate in an interactive activity with the other user. This may facilitate deeper interactions between matched users.

In some implementations, a system configured to facilitate matchmaking between a plurality of users may include one or more of one or more servers, and/or other components. The system may leverage one or more external interactive, electronic social media services. The external interactive, electronic social media services may be configured to provide interactive, electronic social media to users. As used herein, “interactive, electronic social media” may refer to scalable electronic media that enable users to interact with each other. The interactivity provided by interactive, electronic social media may or may not enable realtime interaction.

The one or more servers may include one or more virtual space servers configured to provide, or serve, one or more virtual spaces. The one or more servers may include one or more system servers configured to execute one or more of a user profile module, a match module, an activity provision module, an activity results module, an information release module, a reward module, and/or other modules.

The user profile module may be configured to manage user profiles related to users of the system. The user profiles may include information related to corresponding users of the system. The information included in a given user profile may include, for example, system identification and/or login information, virtual space information, real world contact information, user description information, user match preferences, user activity preferences, and/or other information related to the corresponding user. The information included in the information profiles may be stored to the electronic storage (and/or the electronic storage included in the virtual space servers).

System identification information related to a given user may include information that identifies the given user on the system. By way of non-limiting example, system identification information may include a username. The username may be selected by the user, or may be assigned automatically to the user (e.g., by the user profile module). System identification information may include an identification number or character string, and/or other types of identification information.

Login information related to a given user may include information provided to the system to login and/or authenticate the given user. The information may be provided to the system by the given user via one of the client computing platforms, by the client computing platform implemented by the given user to access the system, and/or otherwise provided to the system to login and/or authenticate the given user. The login information may include, for example, system identification information, a password, information identifying the client computing platform (e.g., MAC address, IP address, a cookie, etc.), and/or other information.

Virtual space information related to a given user may include information related to the avatar representing the given user in the virtual space provided by the virtual space servers. Such information may include, for example, virtual space contact information, avatar description/definition information, virtual space relationship information, inventory information, and/or other information related to the virtual space. Virtual space contact information may enable the given user to be contacted in the virtual space. Such information may include, for example, a name of the avatar of the given user, a chat handle of the given user in the virtual space, a location in the virtual space of a “home” associated with the avatar of the given user, and/or other information. Avatar description/definition information may describe and/or define the appearance of the avatar associated with the given user in the virtual space. Virtual space relationship information may define relationships between the avatar of the given user and other avatars in the virtual space. For example, the virtual space servers may be configured such that the given user may have one or more defined “friends” in the virtual space, may be included in one or more groups, and/or have other relationships in the virtual space. The virtual space relationship information may define these relationships. Inventory information may include an inventory of items, skills, goods, and/or currency held, controlled, and/or owned in the virtual space by the avatar of the given user.

Real world contact information may include information that enables a given user to be contacted in the real world (e.g., not in the virtual space). For example, real world contact information may include information that identifies the given user in the real world, a mailing address of the given user, a phone number in the real world of the given user, a messenger or email account of the given user, and/or other information that enables the given user to be contacted in the real world.

User description information related to a given user may include information that describes the given user and/or the real world situation of the given user. By way of non-limiting example, user description information may include information that describes physical traits of the given user, physical location of the given user in the real world (e.g., region in which the given user lives and/or works), occupation, age, hobbies, interests, and/or other information that describes the given user.

User match preferences related to a given user may include information that identifies preferred traits and/or features of prospective romantic matches for the given user. For example, such information may include information that describes physical traits of prospective romantic matches, physical location of prospective romantic matches in the real world, age, hobbies, interests, and/or other information identifying preferred traits and/or features of prospective romantic matches. User match preferences may include information that has been manually entered and/or configured by the given user and/or may include information determined automatically based on a history of romantic matches of the given user within the system.

As is discussed herein, in the system activities are generated for proposed romantic matches to participate in together. User activity preferences related to a given user may include information related to preferences of the given user with respect to one or more of the activities. By way of example, the user activity preferences may include an interactive, electronic social media preference, a specific activity preference, and/or other preferences. User activity preferences may include information that has been entered and/or configured manually by the given user and/or may include information determined automatically based on analysis of a history of activities previously participated in by the given user.

The match module may be configured to propose romantic matches between users. The romantic matches may be determined and proposed based on preliminary match criteria. The preliminary match criteria may include, for example, one or more of user description information, user match preferences, user histories, and/or other information stored in the user profiles of the users of the system. The match module may implement one or more genetic algorithms configured to determine romantic matches based on an estimate of compatibility between users derived from user description information, user match preferences, user history and/or other information in the user profiles. Individual proposed matches may be scored for compatibility, and the determined compatibility score may be presented to the matched users along with the proposed romantic match.

Romantic matches proposed by the match module may be presented to matched users. As mentioned above, a proposed romantic match may be presented with a compatibility score calculated by the match module that estimates the compatibility of the match. A proposed romantic match may be presented to one of a pair of matched users with user description information from the user profile of the other matched user, user match preferences of the other matched user, and/or other information from the user profile of the other matched user. The proposed romantic match may be devoid of information that would enable the matched users to contact each other directly inside and/or outside of the system.

A matched user may accept or reject a proposed romantic match (e.g., by selecting from a plurality of proposed romantic matches, by individually accepting or rejecting a proposed romantic match). If the proposed romantic match is accepted by the matched user, and the proposed romantic match is also accepted by the other matched user included in the accepted proposed romantic match (e.g., via the corresponding client computing platform), the system may provide one or more activities for the matched users to participate in.

The activity provision module may be configured to provide activities for users based on matches proposed by the match module (e.g., after acceptance of a proposed match). The activities may be conducted via interactive, electronic social media. A given activity may include one or more objectives to be completed by the matched users in the corresponding interactive, electronic social media. An objective in the given activity may be explicitly stated to the users, or may be withheld from the users. Progress toward an objective may be apparent and/or transparent to the users (e.g., a score or some other metric of progress provided to the users). In some implementations, however, one or more objectives may not be made known to the users. Such objectives may be made based on parameters that quantify the compatibility of matched users and/or their enjoyment of a given activity without user knowledge of the quantification.

The interactive, electronic social media associated with the given activity may be a social media provided externally from the system. For example, the social media may be provided by one of the external interactive, electronic social media services. The provision of an activity by the activity provision module for a given pair of matched users may be based on user activity preferences included in the user profile of one or both of the matched users. For example, the social media to be used, the one or more objectives, and/or other parameters of the activity may be based on user activity preferences.

In order to maintain the anonymity of matched users completing an activity in the social media provided by one of external interactive, electronic social media services, provision of an activity may include generation of (or prompting the matched users to generate) two anonymous, and possibly even temporary, user accounts on the external interactive, electronic social media services. In some implementations, rather than generating new user accounts, the matched users may be provided with anonymous user accounts on the external interactive, electronic social media service that are maintained by the match module for use by users of a given activity.

In some external social media, users may implement their existing accounts while the system still maintains the anonymity of matched users. For example, through a social network, such as Facebook™ or MySpace™, users may be directed to widgets and/or applications in which the users participate in an activity provided by the activity provision module anonymously with respect to other users.

If the social media implemented in a given activity is one of the external interactive, electronic social media services, it will be appreciated that “provision” of the activity does not include hosting, serving, or otherwise actually providing the social media to the matched users participating in the given activity. Instead, as used herein, the “provision” of the activity may include identifying the social media to be used, defining the one or more objectives, providing the matched users with a contact information for the other matched user in the social media (e.g., username, account name, and/or other contact information), and/or identifying or defining other parameters of the activity for matched users.

Activities provided by the activity provision module may be designed to encourage meaningful interaction between users to enable evaluations of compatibility by matched users (and/or establish a relationship) prior to releases of user information that enable contact within the virtual space provided by the virtual space servers and/or in the real world. The activities may even be used to obtain matches between users.

A non-limiting example of an activity provided to users by the activity provision module may be a mini-game played asynchronously by users from any of a plurality of possible computing platforms. The mini-game may include components of one or more of luck, skill, and/or chance. Users may play the mini-game competitively (e.g., against each other) and/or cooperatively (e.g., on the same team).

A non-limiting example of an activity provided by the activity provision module may include a numerology game. In the numerology game, a group of users may be asked for a piece of personal information. Such information may include, for example, name, birth date, address, first home address, mother's name, or other information. The users' answers may be shielded from each other to maintain anonymity between the users. From the users' answers, a number may be generated for each of the users. These numbers may be used to give the users a fortune, advice, or some other feedback. The numbers may further be used to refine matching within the group. For example, all of the users that received the number 7 may move on to another round of the game together, while all of the users that receive the number 5 may move on to another round of the game separate from the users that received 7's. The next round may involve requesting a different piece of personal information and repeating the process. This game may be iterated until users have been paired off into matched pairs of users.

Another example of an activity provided to matched users includes a virtual meeting arranged in a virtual setting. For example, a meeting may be arranged in a virtual world for avatars that correspond to matched users. The users may control their avatars to arrive at the designated meeting place and interact with another matched user. The meeting place may include a meeting place commonly used in real life for purposes of meeting people. For example, the meeting place may be a virtual café or shop.

Another example of an activity provided to matched users includes a game in which the matched users participate together. The game may require the matched users to participate competitively and/or cooperatively. For instance, the game may include a card game, such as 21 or Pontoon, that the matched users play against each other and/or a dealer. As another example, the game may take place within a driving/racing game, a shooter, a music game, and/or other games.

The activity results module may be configured to monitor the performance of activities by matched users. Monitoring the performance of activities may include monitoring whether objectives have been accomplished, monitoring interactions (e.g., messages, pictures, etc.) between the matched users during the course of activities, and/or monitoring other aspects of activities. In instances in which activities are performed by matched users in the external interactive, electronic social media services, monitoring such activities may include receiving information from the external interactive, electronic social media services. For example, application programming interfaces, really simple syndication feeds, and/or other mechanisms for receiving information from the external interactive, electronic social media services may be implemented by the activity results module to monitor the activities of matched users in the external interactive, electronic social media services.

From the information received while monitoring the activities of matched users, the activity results module may determine whether matched users engaged in a given activity have achieved one or more objectives of the given activity. As was mentioned above, the one or more objectives may include objectives that are apparent and/or transparent to the users. For example, within a game that is played by the users, the performance of one or both of the users in the game may be directed toward achieving an objective of which the users are aware. However, the one or more objectives may include objectives that are not apparent or transparent to the users. These objectives may be based on parameters that quantify compatibility and/or enjoyment of matched users. For example, time spent participating in an activity, amount of conversation (text and/or voice based), tone of conversation, use of key words and/or phrases in conversation, level of cooperation by matched users during the activity, and/or other parameters may be implemented.

The information release module may be configured to release user information responsive to the performance of matched users in activities provided by the activity provision module. For example, responsive to a given pair of matched users (e.g., a first matched user and a second matched user) achieving an objective of an activity, the information release module may release user information from the user profile of the first matched user to the second matched user and/or may release user information from the user profile of the second matched user to the first matched user. The released information may include, for example, user description information, user match preference information, virtual space information, and/or other user information.

The staged release of such information based on performance of the activities provided by the activity provision module may incent users that are enjoying interaction with each other to complete objectives of the activities. By way of non-limiting example, achievement of a first objective of a given activity by the matched pair of users may result in the release of user description information by the information release module to the matched users. This information may further pique the interest of the matched users, and spur them to complete a second objective. Upon completion of the second objective, the information release module may release additional user description information and/or user contact information (e.g., virtual space contact information).

The reward module may be configured to award rewards to users for participation in activities provided by the activity provision module. The rewards awarded by the reward module may be awarded based on accomplishment of objectives of the activities, for mere participation in activities, for accepting matches proposed by the match module, and/or for other actions taken within the context of the system. Rewards awarded to a given user may be reflected within the user profile of the given user to provide the given user with access to the awarded rewards.

The rewards awarded by the reward module may include rewards that can be redeemed and/or accessed within the virtual space provided by the virtual space servers and/or rewards that can be redeemed and/or accessed outside of the virtual space. Rewards that can be redeemed and/or accessed within the virtual space may include, for example, virtual currency, virtual inventory items, services within the virtual world, and/or other rewards. Rewards that can be redeemed and/or accessed outside of the virtual space may include rewards that can be redeemed and/or accessed in the real world and/or within media other than the virtual space. By way of non-limiting example, such rewards may include real world goods and/or services, virtual currencies and/or goods associated with other interactive, electronic media, and/or other rewards.

The rewards awarded by the reward module may include rewards of a “romantic” value. Such rewards may be provided to a first matched user of a pair of matched users to encourage the first matched user to redeem or access the with or for the benefit of a second matched user in the pair. For example, the reward may be a service and/or good (e.g., dinner, movie, hotel stay, spa treatment, and/or other rewards) usable by and/or for the first and second matched user. As another example, the reward may a service and/or good (e.g., flowers, candy, jewelry, and/or other rewards) that can be gifted between the first and second matched users. In response to an indication by the first matched user and/or the second matched user that a reward awarded to the first or second matched user based on participation in an activity will not be used with and/or for the other matched user, the reward module may be configured to reduce the value of the reward. This may incent users to redeem and/or access rewards for and/or with the users that they participated in activities with to earn the rewards.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate matchmaking between a plurality of users, in accordance with one or more embodiments of the invention.

FIG. 2 is a diagram illustrating domains of various types of activities provided to users by a matchmaking system.

FIG. 3 illustrates a method of facilitating matchmaking between a plurality of users, according to one or more embodiments of the invention.

### DETAILED DESCRIPTION

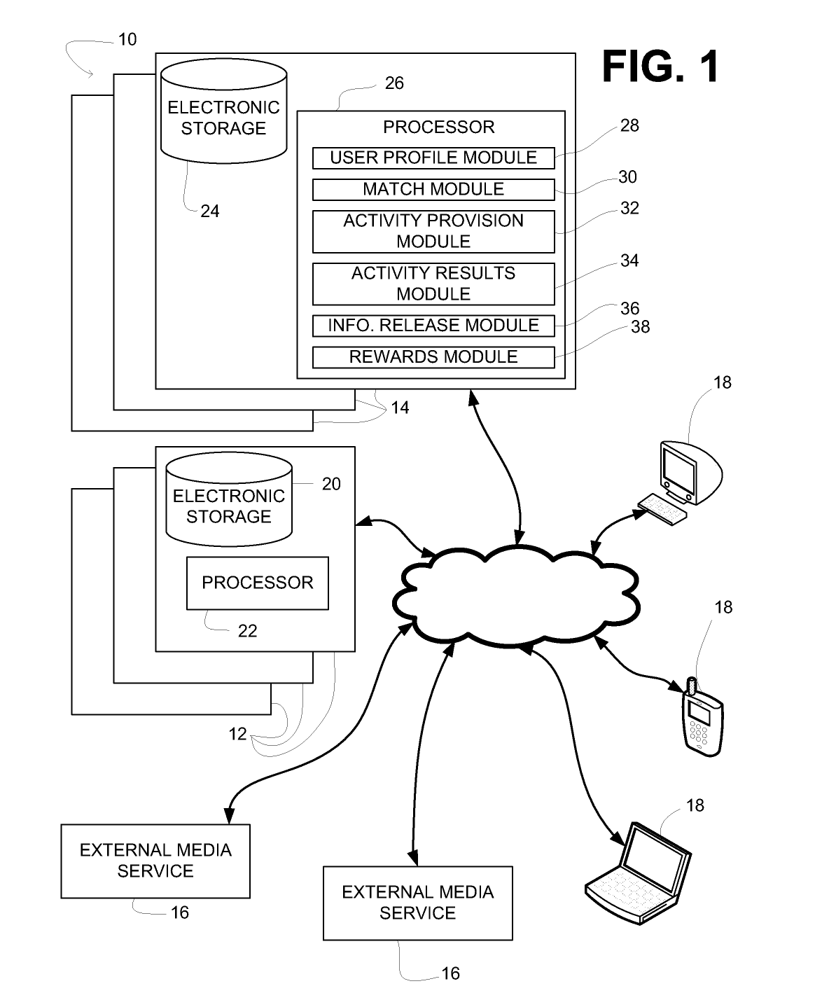

FIG. 1 illustrates a system 10 configured to facilitate matchmaking between a plurality of users. The system may provide a virtual space to the users that enables the user to interact in an immersive manner. The system may propose matches between users, and then may generate activities to be attempted by the matched users. The activities may be conducted via interactive, electronic social media. The interactive, electronic social media may include the virtual space and/or electronic social media hosted by one or more third-parties. Based on the performance of matched users during an activity, system 10 may release user information to the matched users. As such, before a user is provided with at least some types of information about another user, the user must first participate in an interactive activity with the other user. This may facilitate deeper interactions between matched users.

In some implementations, system 10 may include one or more of one or more virtual space servers 12, one or more system servers 14, and/or other components. The system 10 may leverage one or more external interactive, electronic social media services 16. Users may interface with system 10 and/or external interactive, electronic social media services 16 via client computing platforms 18. The components of system 10, virtual space servers 12, system servers 14, external interactive, electronic social media services 16, and/or client computing platforms 18 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which virtual space servers 12, system servers 14, external interactive, electronic social media services 16, and/or client computing platforms 18 are operatively linked via some other communication media.

A given client computing platform 18 may include one or more processors configured to execute computer program modules. The computer program modules may be configured to enable one or more users associated with the given client computing platform 18 to interface with system 10 and/or external interactive, electronic social media services 16, and/or other provide other functionality attributed herein to client computing platforms 18. By way of non-limiting example, the given client computing platform 18 may include one or more of a desktop computer, a laptop computer, a handheld computer, a NetBook, a Smartphone, and/or other computing platforms.

The external interactive, electronic social media services 16 may be configured to provide interactive, electronic social media to users. As used herein, “interactive, electronic social media” may refer to highly accessible, highly scalable media that enable users to interact with each other. The interactivity provided by interactive, electronic social media may or may not enable realtime interaction.

For instance, interactive, electronic social media may include one or more of a social network, a virtual space, a micro-blogging service, a blog service (or host), a browser-based game, a multi-player mobile game, a file (e.g., image file, video file, and/or other files) sharing service, a messaging service, and/or other electronically distributed media that are scalable and enable interaction between the users. The external interactive, electronic social media services 16 are services which are provided by third-parties, or entities not affiliated with the entity that provides and/or maintains system 10. Some non-limiting specific examples of external interactive, electronic social media services 16 may include the micro-blogging service provided by Twitter™, the social network provided by Facebook™, the social network provided by MySpace™, the virtual world provided by SecondLife®, the virtual world building and hosting service provided by Metaplace®, the massively multi-player online game provided by World of Warcraft®, the file sharing service provided by Flickr®, Blogger, YouTube, the virtual world provided by OSGrid, and/or other interactive electronic social media services.

The virtual space server 12 may comprise electronic storage 20, one or more processors 22, and/or other components. The processors 22 may be configured to execute computer program modules. The processors 22 may be configured to execute the computer program modules via one or more of hardware, software, and/or firmware. The computer program modules may be configured to provide, or serve, one or more virtual spaces. Although system 10 may be described in certain sections herein as including virtual space servers 12, this is not intended to be limiting. The virtual space servers 12 may be separate and distinct from system 10, and may be provided by an entity that is separate from, for example, the entity providing system servers 14.

As used herein, a virtual space may comprise a simulated space (e.g., a physical space) instanced on a server (e.g., virtual space servers 12) that is accessible by a client (e.g., client computing platforms 18) located remotely from the server to format a view of the virtual space for display to a user. The simulated space may have a topography, express ongoing real-time interaction by the user, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.).

Within the virtual space provided by virtual space servers 12, avatars associated with the users may be controlled by the users to interact with each other. As used herein, the term “avatar” may refer to an object (or group of objects) present in the virtual space that represents an individual user. The avatar may be controlled by the user with which it is associated. The avatars may interact with each other by physical interaction within the instanced virtual space, through text chat, through voice chat, and/or through other interactions. The avatar associated with a given user may be created and/or customized by the given user. The avatar may be associated with an “inventory” of virtual goods and/or currency that the user can use (e.g., by manipulation of the avatar and/or the items) within the virtual space.

The system servers 14 may include electronic storage 24, one or more processors 26, and/or other components. It will be appreciated that the illustration of virtual space servers 12 and system servers 14 as two separate sets of devices is not intended to be limiting. In some implementations, virtual space servers 12 and system servers 14 may include at least one device in common that performs some or all of the functionality attributed herein to virtual space servers 12 and some or all of the functionality attributed herein to system servers 14.

Electronic storage 24 may comprise electronic storage media that electronically stores information. The electronic storage media of electronic storage 24 may include one or both of system storage that is provided integrally (i.e., substantially non-removable) with system servers 14 and/or removable storage that is removably connectable to system servers 14 via, for example, a port (e.g., a USB port, a firewire port, etc.) or a drive (e.g., a disk drive, etc.). Electronic storage 24 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 24 may store software algorithms, information determined by processor 26, information received from system servers 14, information received from client computing platforms 18, and/or other information that enables system servers 14 to function properly.

Processor(s) 26 is configured to provide information processing capabilities in system servers 14. As such, processor 26 may include one or more of a digital processor, an analog processor, a digital circuit designed to process information, an analog circuit designed to process information, a state machine, and/or other mechanisms for electronically processing information. Although processor 26 is shown in FIG. 1 as a single entity, this is for illustrative purposes only. In some implementations, processor 26 may include a plurality of processing units. These processing units may be physically located within the same device, or processor 26 may represent processing functionality of a plurality of devices operating in coordination.

As is shown in FIG. 1, processor 26 may be configured to execute one or more computer program modules. The one or more computer program modules may include one or more of a user profile module 28, a match module 30, an activity provision module 32, an activity results module 34, an information release module 36, a reward module 38, and/or other modules. Processor 26 may be configured to execute modules 28, 30, 32, 34, 36, and/or 38 by software; hardware; firmware; some combination of software, hardware, and/or firmware; and/or other mechanisms for configuring processing capabilities on processor 26.

It should be appreciated that although modules 28, 30, 32, 34, 36, and 38 are illustrated in FIG. 1 as being co-located within a single processing unit, in implementations in which processor 26 includes multiple processing units, one or more of modules 28, 30, 32, 34, 36, and/or 38 may be located remotely from the other modules. In implementations in which system servers 14 and virtual space servers 12 operate in a coordinated manner to provide the functionality described herein with respect to processor 26, some or all of the functionality attributed to one or more of 28, 30, 32, 34, 36, and/or 38 may be provided by the modules executed on processors 22 of virtual space servers 12. The description of the functionality provided by the different modules 28, 30, 32, 34, 36, and/or 38 described below is for illustrative purposes, and is not intended to be limiting, as any of modules 28, 30, 32, 34, 36, and/or 38 may provide more or less functionality than is described. For example, one or more of modules 28, 30, 32, 34, 36, and/or 38 may be eliminated, and some or all of its functionality may be provided by other ones of modules 28, 30, 32, 34, 36, and/or 38. As another example, processor 26 may be configured to execute one or more additional modules that may perform some or all of the functionality attributed below to one of modules 28, 30, 32, 34, 36, and/or 38.

The user profile module 28 may be configured to manage user profiles related to users of system 10. The user profiles may include information related to corresponding users of system 10. The information included in a given user profile may include, for example, system identification and/or login information, virtual space information, real world contact information, user description information, user match preferences, user activity preferences, and/or other information related to the corresponding user. The information included in the information profiles may be stored to electronic storage 24 (and/or electronic storage 20).

System identification information related to a given user may include information that identifies the given user on system 10. By way of non-limiting example, system identification information may include a username. The username may be selected by the user, or may be assigned automatically to the user (e.g., by user profile module 28). System identification information may include an identification number or character string, and/or other types of identification information.

Login information related to a given user may include information provided to system 10 to login and/or authenticate the given user. The information may be provided to system 10 by the given user via one of client computing platforms 18, by the client computing platform 18 implemented by the given user to access system 10, and/or otherwise provided to system 10 to login and/or authenticate the given user. The login information may include, for example, system identification information, a password, information identifying the client computing platform 18 (e.g., MAC address, IP address, a cookie, etc.), and/or other information.

Virtual space information related to a given user may include information related to the avatar representing the given user in the virtual space provided by virtual space servers 12. Such information may include, for example, virtual space contact information, avatar description/definition information, virtual space relationship information, inventory information, and/or other information related to the virtual space. Virtual space contact information may enable the given user to be contacted in the virtual space. Such information may include, for example, a name of the avatar of the given user, a chat handle of the given user in the virtual space, a location in the virtual space of a “home” associated with the avatar of the given user, and/or other information. Avatar description/definition information may describe and/or define the appearance of the avatar associated with the given user in the virtual space. Virtual space relationship information may define relationships between the avatar of the given user and other avatars in the virtual space. For example, virtual space servers 12 may be configured such that the given user may have one or more defined “friends” in the virtual space, may be included in one or more groups, and/or have other relationships in the virtual space. The virtual space relationship information may define these relationships. Inventory information may include an inventory of items, skills, goods, and/or currency held, controlled, and/or owned in the virtual space by the avatar of the given user.

Real world contact information may include information that enables a given user to be contacted in the real world (e.g., not in the virtual space). For example, real world contact information may include information that identifies the given user in the real world, a mailing address of the given user, a phone number in the real world of the given user, a messenger or email account of the given user, and/or other information that enables the given user to be contacted in the real world.

User description information related to a given user may include information that describes the given user and/or the real world situation of the given user. By way of non-limiting example, user description information may include information that describes physical traits of the given user, physical location of the given user in the real world (e.g., region in which the given user lives and/or works), occupation, age, hobbies, interests, and/or other information that describes the given user.

User match preferences related to a given user may include information that identifies preferred traits and/or features of prospective romantic matches for the given user. For example, such information may include information that describes physical traits of prospective romantic matches, physical location of prospective romantic matches in the real world, age, hobbies, interests, and/or other information identifying preferred traits and/or features of prospective romantic matches. User match preferences may include information that has been manually entered and/or configured by the given user and/or may include information determined automatically based on a history of romantic matches of the given user within system 10.

As is discussed herein, in system 10 activities are generated for proposed romantic matches to participate in together. User activity preferences related to a given user may include information related to preferences of the given user with respect to one or more of the activities. By way of example, the user activity preferences may include an interactive, electronic social media preference, a specific activity preference, and/or other preferences. User activity preferences may include information that has been entered and/or configured manually by the given user and/or may include information determined automatically based on analysis of a history of activities previously participated in by the given user.

The match module 30 may be configured to propose romantic matches between users. The romantic matches may be determined and proposed based on user description information, user match preferences, and/or other information stored in the user profiles of the users of system 10. The match module 30 may implement one or more genetic algorithms configured to determine romantic matches based on an estimate of compatibility between users derived from user description information, user match preferences, and/or other information in the user profiles. Individual proposed matches may be scored for compatibility, and the determined compatibility score may be presented to the matched users along with the proposed romantic match.

Romantic matches proposed by match module 30 may be presented to matched users via client computing platforms 18. As was mentioned above, a proposed romantic match may be presented with a compatibility score calculated by match module 30 that estimates the compatibility of the match. A proposed romantic match may be presented to one of a pair of matched users with user description information from the user profile of the other matched user, user match preferences of the other matched user, and/or other information from the user profile of the other matched user. The proposed romantic match may be devoid of information that would enable the matched users to contact each other directly inside and/or outside of system 10.

Via a user interface presented to a matched user via the corresponding client computing platform 18, the matched user may accept or rejected a proposed romantic match (e.g., by selecting from a plurality of proposed romantic matches, by individually accepting or rejecting a proposed romantic match). If the proposed romantic match is accepted by the matched user, and the proposed romantic match is also accepted by the other matched user included in the accepted proposed romantic match (e.g., via the corresponding client computing platform 18), system 10 may provide one or more activities for the matched users to participate in.

The activity provision module 32 may be configured to provide activities for users based on matches proposed by match module 30 (e.g., after acceptance of a proposed match). The activities may be conducted via interactive, electronic social media. A given activity may include one or more objectives to be completed by the matched users in the corresponding interactive, electronic social media. The interactive, electronic social media associated with the given activity may be a social media provided externally from system 10. For example, the social media may be provided by one of external interactive, electronic social media services 16. The provision of an activity by activity provision module 32 for a given pair of matched users may be based on user activity preferences included in the user profile of one or both of the matched users. For example, the social media to be used, the one or more objectives, and/or other parameters of the activity may be based on user activity preferences.

In order to maintain the anonymity of matched users completing an activity in the social media provided by one of external interactive, electronic social media services 16, provision of an activity may include generation of (or prompting the matched users to generate) two anonymous, and possibly even temporary, user accounts on external interactive, electronic social media services 16. In some implementations, rather than generating new user accounts, the matched users may be provided with anonymous user accounts on external interactive, electronic social media service 16 that are maintained by match module 30 for use by users of a given activity.

In some external social media, users may implement their existing accounts while system 10 still maintains the anonymity of matched users. For example, through a social network, such as Facebook™ or MySpace™, users may be directed to widgets and/or applications in which the users participate in an activity provided by the application provision module 32 anonymously with respect to other users.

If the social media implemented in a given activity is one of external interactive, electronic social media services 16, it will be appreciated that “provision” of the activity does not include hosting, serving, or otherwise actually providing the social media to the matched users participating in the given activity. Instead, as used herein, the “provision” of the activity may include identifying the social media to be used, defining the one or more objectives, providing the matched users with contact information for the other matched user in the social media (e.g., username, account name, and/or other contact information), and/or identifying or defining other parameters of the activity for matched users.

Activities provided by activity provision module 32 may be designed to encourage meaningful interaction between users to enable evaluations of compatibility by matched users (and/or establish a relationship) prior to releases of user information that enable contact within the virtual space provided by virtual space servers 12 and/or in the real world. The activities provided by activity provision module 32 may even be used to determine and/or refine matches between users.

A non-limiting example of an activity provided to users by the activity provision module 32 may be a mini-game played asynchronously by users from any of a plurality of possible computing platforms. The mini-game may include components of one or more of luck, skill, and/or chance. Users may play the mini-game competitively (e.g., against each other) and/or cooperatively (e.g., on the same team).

A non-limiting example of an activity provided by the activity provision module 32 may include a numerology game. In the numerology game, a group of users may be asked for a piece of personal information. Such information may include, for example, name, birth date, address, first home address, mother's name, or other information. The users' answers may be shielded from each other to maintain anonymity between the users. From the users' answers, a number may be generated for each of the users. These numbers may be used to give the users a fortune, advice, or some other feedback. The numbers may further be used to refine matching within the group. For example, all of the users that received the number 7 may move on to another round of the game together, while all of the users that receive the number 5 may move on to another round of the game separate from the users that received 7's. The next round may involve requesting a different piece of personal information and repeating the process. This game may be iterated until users have been paired off into matched pairs of users.

Another example of an activity provided to matched users includes a virtual meeting arranged in a virtual setting. For example, a meeting may be arranged in a virtual world for avatars that correspond to matched users. The users may control their avatars to arrive at the designated meeting place and interact with the other matched user. The meeting place may include a meeting place commonly used in real life for purposes of meeting people. For example, the meeting place may be a virtual café or shop.

Another example of an activity provided to matched users includes a game in which the matched users participate together. The game may require the matched users to participate competitively and/or cooperatively. For instance, the game may include a card game, such as 21 or Pontoon, that the matched users play against each other and/or a dealer. As another example, the game may take place within a driving/racing game, a shooter, a music game, and/or other games.

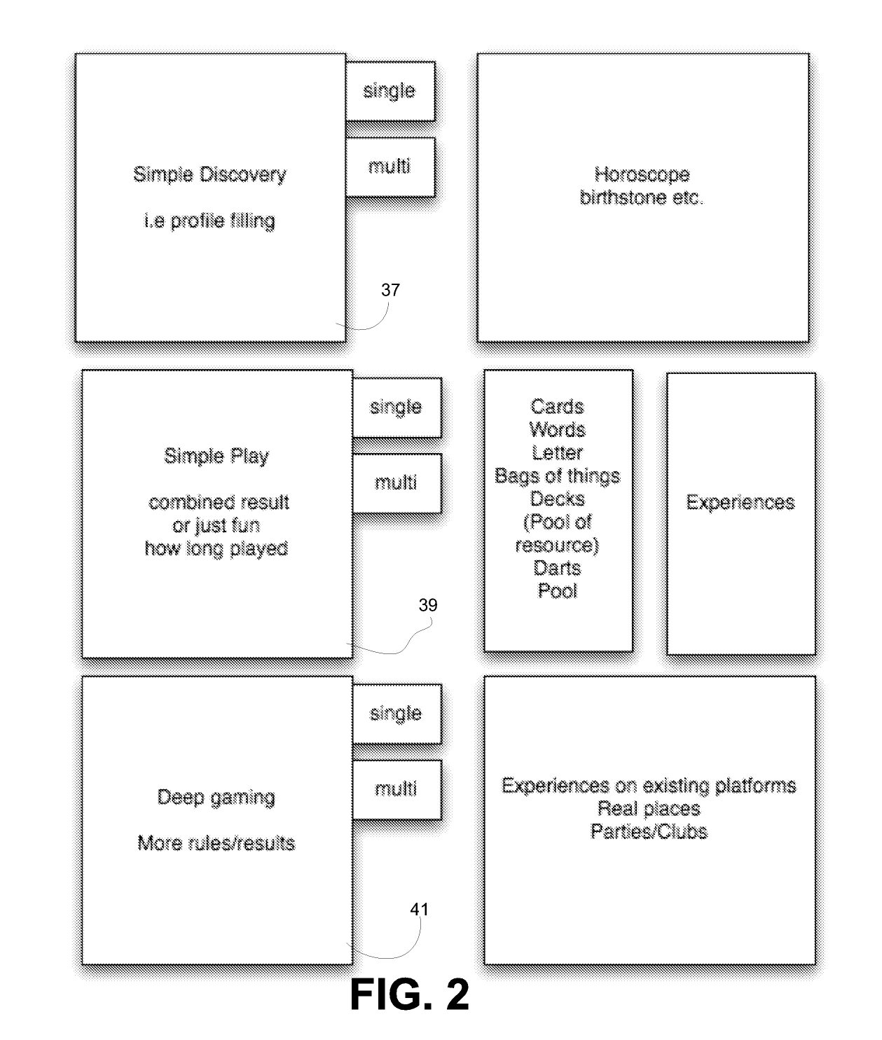

As matched users continue to participate in activities together, the depth, richness, complexity, and/or other facets of the activities provided to the matched users by activity provision module 32 may increase. For example, FIG. 2 provides a schematic that conceptually depicts several different domains of activities through which a given matched pair of users may progress. Of course, the activities may be provided to users by activity provision module 32 across the different domains shown without requiring “progression.” For instance, one or more users may prefer activities within a given one of the domains. This preference may be affirmatively configured by the users, or determined through observation by processor 26.

The domains of activities shown in FIG. 2 may include a simple discovery domain 37, a simple play domain 39, a deep gaming domain 41, and/or other domains. The simple discovery domain 37 may include activities involving primarily providing and receiving personal (typically non-identifying) information. Such information may include, for example, astrology sign, birthstone, lucky numbers/days, personal preferences, and/or other information. The activities may be designed as interesting games that incrementally elicit the information from the users. The simple play domain 39 may include activities that involve simple game mechanics, may be session based, and/or may not require extensive skill built up over repetitive participation. The deep gaming domain 41 may include activities that involve more sophisticated game and/or control mechanics, persistent environments, and/or third party platforms.

Returning to FIG. 1, the activity results module 34 may be configured to monitor the performance of activities by matched users. Monitoring the performance of activities may include monitoring whether objectives have been accomplished, monitoring interactions (e.g., messages, pictures, etc.) between the matched users during the course of activities, and/or monitoring other aspects of activities. In instances in which activities are performed by matched users in external interactive, electronic social media services 16, monitoring such activities may include receiving information from the external interactive, electronic social media services 16. For example, application programming interfaces, really simple syndication feeds, and/or other mechanisms for receiving information from external interactive, electronic social media services 16 may be implemented by activity results module 34 to monitor the activities of matched users in external interactive, electronic social media services 16.

In some implementations, monitoring the performance of activities by matched users includes requesting the matched users to provide information related to the activities. For example, after participating in an activity, a pair of matched users may each be queried individually (e.g., by email, text, user account query, and/or other communication) about the activity. This query may include a request for subjective information from each of the matched users with respect to how the activity went. The subjective information may include a rating with respect to one or more aspects of the activity and/or the other matched user.

From the information received while monitoring the activities of matched users, the activity results module 34 may determine whether matched users engaged in a given activity have achieved one or more objectives of the given activity. As was mentioned above, the one or more objectives may include objectives that are apparent and/or transparent to the users. For example, within a game that is played by the users, the performance of one or both of the users in the game may be directed toward achieving an objective of which the users are aware. However, the one or more objectives may include objectives that are not apparent or transparent to the users. These objectives may be based on parameters that quantify compatibility and/or enjoyment of matched users. For example, time spent participating in an activity, amount of conversation (text and/or voice based), tone of conversation, use of key words and/or phrases in conversation, level of cooperation by matched users during the activity, subjective rating of an activity by the matched users after the activity has occurred, and/or other parameters may be implemented.

The information release module 36 may be configured to release user information responsive to the performance of matched users in activities provided by activity provision module 32. For example, responsive to a given pair of matched users (e.g., a first matched user and a second matched user) achieving an objective of an activity, information release module 36 may release user information from the user profile of the first matched user to the second matched user and/or may release user information from the user profile of the second matched user to the first matched user. The released information may include, for example, user description information, user match preference information, virtual space information, and/or other user information.

The staged release of such information based on performance of the activities provided by activity provision module 32 may incent users that are enjoying interaction with each other to complete objectives of the activities. By way of non-limiting example, achievement of a first objective of a given activity by the matched pair of users may result in the release of user description information by information release module 36 to the matched users. This information may further pique the interest of the matched users, and spur them to complete a second objective. Upon completion of the second objective, information release module 36 may release additional user description information and/or user contact information (e.g., virtual space contact information).

The reward module 38 may be configured to award rewards to users for participation in activities provided by activity provision module 32. The rewards awarded by reward module 38 may be awarded based on accomplishment of objectives of the activities, for mere participation in activities, for accepting matches proposed by match module 30, and/or for other actions taken within the context of system 10. Rewards awarded to a given user may be reflected within the user profile of the given user to provide the given user with access to the awarded rewards.

The rewards awarded by reward module 38 may include rewards that can be redeemed and/or accessed within the virtual space provided by virtual space servers 12 and/or rewards that can be redeemed and/or accessed outside of the virtual space. Rewards that can be redeemed and/or accessed within the virtual space may include, for example, virtual currency, virtual inventory items, services within the virtual world, and/or other rewards. Rewards that can be redeemed and/or accessed outside of the virtual space may include rewards that can be redeemed and/or accessed in the real world and/or within media other than the virtual space. By way of non-limiting example, such rewards may include real world goods and/or services, virtual currencies and/or goods associated with other interactive, electronic media, and/or other rewards.

The rewards awarded by reward module 38 may include rewards of a “romantic” value. Such rewards may be provided to a first matched user of a pair of matched users to encourage the first matched user to redeem or access the rewards with or for the benefit of a second matched user in the pair. For example, the reward may be a service and/or good (e.g., dinner, movie, hotel stay, spa treatment, and/or other rewards) usable by and/or for the first and second matched user. As another example, the reward may be a service and/or good (e.g., flowers, candy, jewelry, and/or other rewards) that can be gifted between the first and second matched users. In response to an indication by the first matched user and/or the second matched user that a reward awarded to the first or second matched user based on participation in an activity will not be used with and/or for the other matched user, reward module 38 may be configured to reduce the value of the reward. This may incent users to redeem and/or access rewards for and/or with the users that they participated in activities with to earn the rewards.

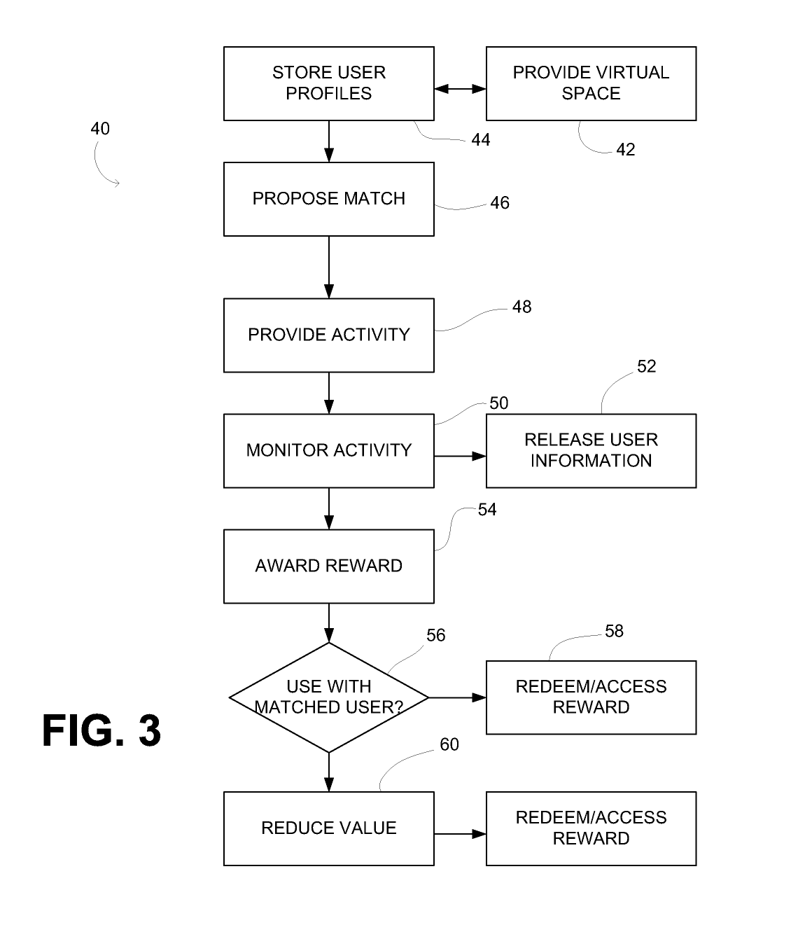

FIG. 3 illustrates a method 40 of facilitating matchmaking between a plurality of users. The operations of method 40 presented below are intended to be illustrative. In some embodiments, method 40 may be accomplished with one or more additional operations not described, and/or without one or more of the operations discussed. Additionally, the order in which the operations of method 40 are illustrated in FIG. 3 and described below is not intended to be limiting.

In some embodiments, method 40 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 40 in response to instructions stored electronically on an electronic storage medium. The one or more processing devices may include one or more devices configured through hardware, firmware, and/or software to be specifically designed for execution of one or more of the operations of method 40.

At an operation 42, a virtual space may be provided to a plurality of users. The virtual space may be populated with avatars that represent the plurality of users in the virtual space. In some implementations, operation 42 may be performed by one or more virtual space servers that are the same as or similar to virtual space servers 12 (shown in FIG. 1 and described above).

At an operation 44, user profiles corresponding to the users may be stored. The user profiles may be stored to electronic storage media. The user profiles may include user information related to the users. The user information may include one or more of system identification and/or login information, virtual space information (e.g., related to the virtual space provided at operation 42), real world contact information, user description information, user match preferences, user activity preferences, and/or other information related to users. In some implementations, operation 44 may be performed by a user profile module that is the same as or similar to user profile module 28 (shown in FIG. 1 and described above).

At an operation 46, a romantic match between a first user and a second user may be proposed. The proposed romantic match between the first user and the second user may be based on user information included in the user profile corresponding to the first user and on user information included in the user profile corresponding to the second user. In some implementations, operation 46 may be performed by a match module that is the same as or similar to match module 30 (shown in FIG. 1 and described above).

At an operation 48, responsive to the romantic match proposed at operation 46, an activity may be provided to the first user and the second user. The activity may be conducted via interactive, electronic social media. The activity may have one or more objectives to be completed by the first user and the second user in the interactive, electronic social media. In some implementations, operation 48 may be performed by an activity provision module that is the same as or similar to activity provision module 32 (shown in FIG. 1 and described above). In some implementations, the interactive, electronic social media may be provided by a third-party. For example, the interactive electronic social media may be provided by a external interactive, electronic social media service that is the same as or similar to an external interactive, electronic social media services 16 (shown in FIG. 1 and described above).

At an operation 50, performance of the activity by the first user and the second user may be monitored. Monitoring performance of the activity by the first user and the second user may include determining whether the first user and the second user have accomplished any of the objectives of the activity. In some implementations, operation 50 may be performed by an activity results module that is the same as or similar to activity results module 34 (shown in FIG. 1 and described above).

At an operation 52, responsive to the first user and the second user accomplishing an objective of the activity, user information from the user profiles corresponding to the first user and the second user may be released. This may include releasing user information from the user profile associated with the first user to the second user and/or releasing user information from the user profile associated with the second user to the first user. In some implementations, operation 52 may be accomplished by an information release module that is the same as or similar to information release module 36 (shown in FIG. 1 and described above).

At an operation 54, responsive to participation of the first user and the second user in the activity (e.g., to accomplishment of an objective, to beginning the activity, etc.) a reward may be awarded to the first user and/or the second user. In some implementations, operation 54 may be performed by a reward module that is the same as or similar to reward module 38 (shown in FIG. 1 and described above).

The reward awarded to the first user and/or the second user at operation 54 may be redeemable and/or accessible with or for the other of the matched users. At an operation 56, a determination may be made as to whether the reward is to be redeemed and/or accessed with or for the other of the matched users. This may include determining the reward is to be redeemed and/or accessed with or for the other matched users based on a request to redeem and/or access the reward with or for the other matched user. In response to such a determination, method 40 may proceed to an operation 58. At operation 58, the reward may be redeemed and/or accessed by the matched user(s) (the first and/or the second users).

At operation 56, a determination may be made that the reward is not to be redeemed and/or accessed with or for the other matched user based on receipt of an indication from the first and/or and the second user that this will be the case. If such a determination is made, method 40 may proceed to an operation 60. At operation 60, the value of the reward may be reduced based on the determination made at operation 56.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to facilitate real world dating between a plurality of users, the system comprising:
electronic storage configured to store user profiles corresponding to users, the user profiles comprising:
a first user profile that includes user information related to a first user, the user information comprising real world contact information, virtual space contact information, user description information, user match preferences, and match activity preferences; and
a second user profile that includes user information related to a second user, the user information comprising real world contact information, virtual space contact information, user description information, user match preferences, and match activity preferences;
one or more virtual space servers including one or more processors configured to execute computer program modules, the computer program modules being configured to serve a virtual space in which avatars representing the users are controlled by the users to interact;
one or more system servers including one or more processors configured to execute computer program modules, the computer program modules comprising:
a match module configured to propose romantic matches between users based on user description information;
an activity provision module configured to provide activities for users based on matches proposed by the match module, wherein the activities are conducted via interactive, electronic social media, and wherein the activities are generated such that responsive to a proposed romantic match between the first user and the second user the activity module provides an activity to the first user and the second user that the first user and the second user participate in via interactive, electronic social media, the activity for the first user and the second user having one or more objectives to be completed by the first user and the second user in the interactive, electronic social media; and
an information release module configured such that responsive to the first user and the second user completing an objective of the activity via the interactive, electronic social media, the information release module provides:
virtual space contact information from the first user profile to the second user that enables the second user to locate an avatar in the virtual space representing the first user, and
virtual space contact information from the second user profile to the first user that enables the first user to locate an avatar in the virtual space representing the second user.

2. The system of claim 1, wherein the one or more processors of the one or more system servers are further configured to execute:
an activity results module configured to monitor the progress of users in activities generated by the activity provision module.

3. The system of claim 1, wherein the activity provision module is configured such that the activities generated for users include activities conducted via the virtual space served by the one or more virtual space servers.

4. The system of claim 1, wherein the activity provision module is configured such that the activities generated for users include activities conducted via interactive, electronic social media hosted externally from the system.

5. The system of claim 4, wherein the interactive, electronic social media hosted externally from the system comprise one or more of a social network, a virtual space, a micro-blogging service, or a browser-based game.

6. The system of claim 1, wherein the match module is configured such that proposed romantic matches between users are based on match preference information.

7. The system of claim 1, wherein the activity provision module is configured such that the activity generated responsive to the match proposed for the first user and the second user is further based on the match activity preferences included in the first user profile and the second user profile.

8. The system of claim 1, wherein the first user profile further includes results of activities previously participated in by the first user, wherein the second user profile further includes results of activities previously participated in by the second user, and wherein the activity provision module is configured such that the activity generated responsive to the match proposed for the first user and the second user is further based on the results of activities previously participated in by the first user and the results of activities previously participated in by the second user.

9. The system of claim 1, wherein the one or more processors of the one or more system servers are further configured to execute:
a rewards module configured to provide users with rewards for participation in activities such that responsive to participation by the first user and the second user in the activity generated by the activity provision module the rewards module provides a reward to the first user and the second user.

10. The system of claim 1, wherein the rewards module is configured such that the reward provided to the first user and the second user is usable by the first user and the second user together.

11. The system of claim 10, wherein the rewards module is configured such that responsive to an indication from the first user and/or the second user that the first user and/or the second user will not use the reward together, the value of the reward is reduced.

12. The system of claim 10, wherein the reward comprises virtual currency or one or more virtual goods awarded to the first user and/or the second user in the virtual space.

13. A method of facilitating real world dating between a plurality of users, the method comprising:
storing to electronic storage media user profiles corresponding to users, the user profiles comprising:
a first user profile that includes user information related to a first user, the user information comprising real world contact information, virtual space contact information, user description information, user match preferences, and match activity preferences; and
a second user profile that includes user information related to a second user, the user information comprising real world contact information, virtual space contact information, user description information, user match preferences, and match activity preferences;
executing, on one or more processors of one or more virtual space servers, computer program modules configured to serve a virtual space in which avatars representing the users are controlled by the users to interact;
proposing a romantic match between the first user and the second user based on user description information included in the first user profile and the second user profile;
providing an activity to first user and the second user responsive to the proposed romantic match between the first user and the second user, wherein the activity is conducted via interactive, electronic social media, and wherein the activity for the first user and the second user has one or more objectives to be completed by the first user and the second user in the interactive, electronic social media; and
responsive to the first user and the second user completing an objective of the activity via the interactive, electronic social media, releasing user information to the first user and the second user, wherein the released user information comprises:
virtual space contact information from the first user profile released to the second user that enables the second user to locate an avatar in the virtual space representing the first user, and
virtual space contact information from the second user profile released to the first user that enables the first user to locate an avatar in the virtual space representing the second user.

14. The method of claim 13, further comprising monitoring the progress of the first user and the second user in the activity.

15. The method of claim 13, wherein the activity generated for the first user and the second user is conducted via the virtual space served by the one or more virtual space servers.

16. The method of claim 13, wherein the activity generated for the first user and the second user is conducted via interactive, electronic social media hosted by a third-party provider.

17. The method of claim 16, wherein the interactive, electronic social media hosted by a third-party comprise one or more of a social network, a virtual space, a micro-blogging service, or a browser-based game.

18. The method of claim 13, wherein the proposed romantic match between the first user and the second user is based on match preference information in the first user profile and match preference information in the second user profile.

19. The method of claim 13, wherein the activity generated for the first user and the second user is further based on the match activity preferences included in the first user profile and the second user profile.

20. The method of claim 13, wherein the first user profile further includes results of activities previously participated in by the first user, wherein the second user profile further includes results of activities previously participated in by the second user, and wherein the activity generated responsive to the match proposed for the first user and the second user is further based on the results of activities previously participated in by the first user and the results of activities previously participated in by the second user.

21. The method of claim 13, further comprising providing the first user and the second user with a reward for participation in the activity.

22. The method of claim 13, wherein the reward provided to the first user and the second user is usable by the first user and the second user together.

23. The method of claim 22, further comprising:
receiving an indication from the first user and/or the second user that the first user and/or the second user will not use the reward together; and
responsive to reception of the indication, reducing the value of the reward.

24. The method of claim 22, wherein the reward comprises virtual currency or one or more virtual goods awarded to the first user and/or the second user in the virtual space.
